(19) United States
(12) Patent Application Publication
(10) Pub. No.: US 2026/0161684 A1
(43) Pub. Date: Jun. 11, 2026

(54) QUESTION ANSWERING METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Jin MA, Shenzhen (CN); Jingdong CHANG, Shenzhen (CN); Yifeng SHAO, Shenzhen (CN)

(21) Appl. No.: 19/220,047

(22) Filed: May 27, 2025

Related U.S. Application Data
(63) Continuation of application No. PCT/CN2023/132207, filed on Nov. 17, 2023.

(30) Foreign Application Priority Data
May 11, 2023 (CN) 202310525663.4

(51) Int. Cl. G06F 16/3329; G06F 16/355

(52) U.S. Cl. CPC G06F 16/33295; G06F 16/355

(57) ABSTRACT

Embodiments of this application provide a question answering method and apparatus. The method includes obtaining a question to be answered, question complexity of the question to be answered being greater than a complexity threshold; performing question decomposition on the question to be answered to obtain a plurality of sub-questions, the question decomposition model being a model obtained through training by using a first quantity of supervised data and a second quantity of weakly-supervised data as sample data; querying each of the sub-questions by using a search engine, to obtain a reference information set of the plurality of sub-questions; inputting the question to be answered and the reference information set to a preset natural language processing model; and answering the question based on reference information in the reference information set by using the natural language processing model, to obtain an answer result of the question to be answered.

### RELATED APPLICATIONS

This application is a continuation of PCT Application No. PCT/CN2023/132207, filed on Nov. 17, 2023, which in turn claims priority to Chinese Patent Application No. 202310525663.4, entitled “QUESTION ANSWERING METHOD AND APPARATUS, ELECTRONIC DEVICE, COMPUTER-READABLE STORAGE MEDIUM, AND COMPUTER PROGRAM PRODUCT” filed on May 11, 2023, which are both incorporated by reference in their entirety.

### FIELD OF THE TECHNOLOGY

Embodiments of this application relate to the field of the Internet, and relate to, but are not limited to, a question answering method and apparatus, an electronic device, a computer-readable storage medium, and a computer program product.

### BACKGROUND OF THE DISCLOSURE

With the technical innovation of the chat generative pre-trained transformer (ChatGPT), more and more enterprises develop ChatGPT type projects. However, most models have problems such as fact mistakes and fact fabrications, baseless logical or fact mistakes, and lack of richness and reasonableness, which easily mislead users.

To solve such problems, currently, most search engines in the industry usually use a chain of thought method when improving search capabilities by using a ChatGPT technology; or a search engine searches based on a user question to obtain a search result, and enables the model to generate an answer according to the search result during question answering, to improve reasoning accuracy.

However, in the chain of thought method, a large number of samples with reasoning processes need to be constructed, causing high construction difficulty and high labor costs. In addition, it needs to be ensured that, for a reference sample and a current question, distributions and categories are consistent, and reasoning processes are similar. Once a cross-category sample question occurs, the output effect is very poor. In the method in which the search engine performs searches to obtain the search result, a sub-question decomposition and answering process of the entire question are serial, which consumes long processing time. In addition, when the model is large, the overall calculation amount is excessively large, and question decomposition cannot be independently performed. Therefore, the solutions in the related arts all have problems such as high difficulty in sample construction and large calculation amount. As such, more calculation resources need to be provided to implement an effective question answering process, which causes high resource consumption.

### SUMMARY

Embodiments of this application provide a question answering method and apparatus, an electronic device, a computer-readable storage medium, and a computer program product, which can be applied to at least the field of artificial intelligence and the field of information searching, and can greatly improve question answering efficiency, thereby reducing resource consumption in a question answering process.

Technical solutions of the embodiments of this application are implemented as follows:

One aspect of this application provides a question answering method, performed by an electronic device. The method includes obtaining a question to be answered, question complexity of the question to be answered being greater than a complexity threshold; performing question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a ratio existing between the first quantity and the second quantity; querying each of the sub-questions by using a search engine, to obtain a reference information set of the plurality of sub-questions; inputting the question to be answered and the reference information set to a preset natural language processing model; and answering the question to be answered based on reference information in the reference information set by using the natural language processing model, to obtain an answer result of the question to be answered.

Another aspect of this application provides an electronic device, including: a memory, configured to store executable instructions; and a processor, configured to implement, when executing the executable instructions stored in the memory, the foregoing question answering method.

Another aspect of this application provides a non-transitory computer-readable storage medium, having executable instructions stored therein, the computer-readable storage medium being configured to cause a processor to implement the foregoing question answering method when executing the executable instructions.

The embodiments of this application have the following beneficial effects:

In embodiments consistent with the present disclosure, question decomposition is performed on a question to be answered by using a pre-trained question decomposition model, to obtain a plurality of sub-questions corresponding to the question to be answered. The question decomposition model is a model obtained through training by using a first quantity of supervised data and a second quantity of weakly-supervised data as sample data. Accordingly, because the first quantity is less than the second quantity, that is, the quantity of supervised data is less than the quantity of weakly-supervised data, the question decomposition model can be trained by using a small quantity of supervised data that are manually labeled and a large quantity of weakly-supervised data that do not need to be manually labeled, thereby greatly reducing difficulty and costs of constructing the sample data and improving efficiency of constructing the sample data.

In embodiments consistent with the present disclosure, each of the sub-questions is queried by using a search engine, to obtain a reference information set of the plurality of sub-questions; and the question to be answered and the reference information set are inputted to a preset natural language processing model, and the question to be answered is answered by using the natural language processing model based on reference information in the reference information set, to obtain an answer result of the question to be answered. Accordingly, querying processes of the plurality of sub-questions may be performed in parallel, and the final answer result is determined based on the reference information in the queried reference information set, thereby improving question answering efficiency, reducing resource consumption in the question answering process, and ensuring accuracy of the obtained answer result.

### BRIEF DESCRIPTION OF THE DRAWINGS

FIG. 1 is a schematic diagram of an architecture of a question answering system according to an embodiment of this application.

FIG. 2 is a schematic structural diagram of an electronic device according to an embodiment of this application.

FIG. 3 is a schematic flowchart of an example of a question answering method according to an embodiment of this application.

FIG. 4 is a schematic flowchart of a method for obtaining supervised data according to an embodiment of this application.

FIG. 5 is a schematic flowchart of an implementation of data filtering according to an embodiment of this application.

FIG. 6 is a schematic flowchart of an implementation of category balance analysis according to an embodiment of this application.

FIG. 7 is a schematic flowchart of an implementation of updating a question classification system according to an embodiment of this application.

FIG. 8 is a schematic flowchart of a method for obtaining weakly-supervised data according to an embodiment of this application.

FIG. 9 is a schematic flowchart of a method for training a question decomposition model according to an embodiment of this application.

FIG. 10 is a schematic diagram of a working manner of a conventional answer generation model and a chain of thought.

FIG. 11 is a flowchart of a working manner of a self-ask method generated according to a search result by using a model in the related arts.

FIG. 12 is a schematic flowchart of a working manner of a self-ask method generated according to a search result by using a model in combination with a search engine in the related arts.

FIG. 13 is a block diagram of a question answering method according to an embodiment of this application.

FIG. 14 is a schematic diagram of a question classification system according to an embodiment of this application.

FIG. 15 is a schematic diagram of constructing weakly-supervised data based on a few-shot technology according to an embodiment of this application.

FIG. 16 is a schematic structural diagram of a transformer model according to an embodiment of this application.

FIG. 17 is a schematic diagram of evolution of a GPT model according to an embodiment of this application.

FIG. 18 is a comparison diagram between experimental effects of different models used by a question decomposition system according to an embodiment of this application.

FIG. 19 is a comparison diagram between answer richness without question decomposition and answer richness with question decomposition according to an embodiment of this application.

FIG. 20 is a comparison diagram between answer reasonableness without question decomposition and answer reasonableness with question decomposition according to an embodiment of this application.

### DESCRIPTION OF EMBODIMENTS

To make the objectives, technical solutions, and advantages of this application clearer, the following describes this application in further detail with reference to the accompanying drawings. The embodiments described are not to be considered as a limitation to this application. All other embodiments obtained by a person of ordinary skill in the related art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict. Unless otherwise defined, the meanings of all technical and scientific terms used in this specification used in embodiments of this application are the same as those usually understood by a person skilled in the related art to which the embodiments of this application belong. Terms used in the embodiments of this application are merely intended to describe objectives of the embodiments of this application, but are not intended to limit this application.

When a ChatGPT answers a question, a hallucination, a confabulation, poor richness, poor reasonableness, and baseless logical or fact mistakes exist. For the problems, currently, most search engines in the industry usually use existing search capabilities to find references when improving search capabilities by using a ChatGPT technology. When a model generates an answer, the model summarizes the answer from a reference (that is, the answer with the reference), to replace the original end-to-end answer generation of the model. However, for a ChatGPT item, when a user question is a factual question or a complex and extra-long question, a search system cannot accurately provide a search reference for the user question.

For the problem, in the embodiments of this application, question categories are defined, knowledge point decomposition is performed, and a question decomposition sample is constructed in a manner of manual labeling and weak supervision generation, to train a question decomposition model. Generated sub-questions each have independent knowledge points, are semantically independent and non-repetitive, and cover all knowledge required an original question. The search system is requested to obtain a reference for each of the sub-questions by using a sub-task, and references for the sub-questions are collected as an entire reference to be provided to a ChatGPT model for answer reasoning, thereby greatly improving answer accuracy, richness, and reasonableness of the ChatGPT model and reducing a hallucination and a confabulation of the model when answering the factual question and the complex and extra-long question.

A question answering method provided in an embodiment of this application includes: first, obtaining a question to be answered, question complexity of the question to be answered being greater than a complexity threshold; then, performing question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a particular ratio existing between the first quantity and the second quantity; then, querying each of the sub-questions by using a search engine to obtain a reference information set of the plurality of sub-questions; and finally, inputting the question to be answered and the reference information set to a preset natural language processing model, and answering, by using the natural language processing model, the question to be answered based on reference information in the reference information set, to obtain an answer result of the question to be answered. Accordingly, because the first quantity is less than the second quantity, that is, the quantity of supervised data is less than the quantity of weakly-supervised data, the question decomposition model can be trained by using a small quantity of supervised data that are manually labeled and a large quantity of weakly-supervised data that do not need to be manually labeled, thereby greatly reducing difficulty and costs of constructing the sample data and improving efficiency of constructing the sample data. In addition, querying processes of the plurality of sub-questions may be performed in parallel, and the final answer result is determined based on the reference information in the queried reference information set, thereby improving question answering efficiency, reducing resource consumption in the question answering process, and ensuring accuracy of the obtained answer result.

An application of a question answering device in the embodiments of this application is first described. The question answering device is an electronic device configured to implement the question answering method. In an implementation, the question answering device (namely, the electronic device) provided in the embodiments of this application may be implemented as a terminal, or may be implemented as a server. In an implementation, the question answering device provided in the embodiments of this application may be implemented as any terminal having a data processing function and a question answering function, such as a laptop computer, a tablet computer, a desktop computer, a mobile phone, a portable music player, a personal digital assistant, a specialized messaging device, a portable game device, an intelligent robot, a smart appliance, or an intelligent in-vehicle device. In another implementation, the question answering device provided in the embodiments of this application may alternatively be implemented as a server. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middle-ware service, a domain name service, a security service, a content delivery network (CDN), big data, and an artificial intelligence platform. The terminal and the server may be directly or indirectly connected in a wired or wireless communication manner. This is not limited in the embodiments of this application. An application when the question answering device is implemented as a server is described below.

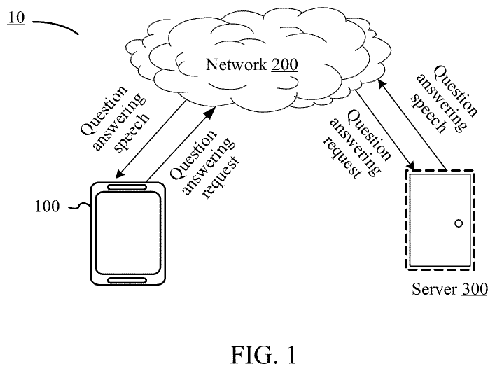

FIG. 1 is a schematic diagram of an architecture of a question answering system according to an embodiment of this application. In this embodiment of this application, description is made by using an example in which the question answering method is applied to any category of question answering application. When the question answering application receives, during running, a question to be answered inputted by a user, the question answering application needs to answer the question to be answered of the user. In this case, an answer result of the question to be answered may be generated by using the question answering method provided in this embodiment of this application, and the answer result is outputted to the user by using the question answering application. In this embodiment of this application, a question answering system 10 includes at least one terminal 100, a network 200, and a server 300. The server 300 may be a server of the question answering application. The server 300 may form the question answering device in the embodiments of this application. The terminal 100 is connected to the server 300 by using the network 200. The network 200 may be a wide area network, a local area network, or a combination thereof.

In this embodiment of this application, the question answering application runs on the terminal 100. During question answering, the terminal receives the question to be answered inputted by the user in a form of speech or text, encapsulates the question to be answered into a question answering request, and transmits the question answering request to the server 300 by using the network 200. The server 300 performs, in response to the question answering request, question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a particular ratio existing between the first quantity and the second quantity; then queries each of the sub-questions by using a search engine, to obtain a reference information set of the plurality of sub-questions; and finally inputs the question to be answered and the reference information set to a preset natural language processing model, and answers, by using the natural language processing model, the question to be answered based on reference information in the reference information set, to obtain an answer result of the question to be answered. After the answer result of the question to be answered is obtained, the server 300 may convert the answer result of the question to be answered into a question answering speech, and transmit the question answering speech to the terminal 100, to output the question answering speech on the terminal. After the answer result of the question to be answered is obtained, the server 300 may alternatively directly transmit answering text corresponding to the answer result of the question to be answered to the terminal 100; and the terminal 100 directly displays the answering text on a current interface, or the terminal 100 performs speech conversion on the answering text to obtain and output a question answering speech.

In some embodiments, the question answering method may alternatively be implemented by using a terminal. In other words, the question answering application is mounted on the terminal 100, and the user inputs the question to be answered by using a client of the question answering application. After the terminal receives the question to be answered from the client, the terminal performs question decomposition on the question to be answered by using a pre-trained question decomposition model, to obtain a plurality of sub-questions corresponding to the question to be answered; then, the terminal queries each of the sub-questions by using a search engine, to obtain a reference information set of the plurality of sub-questions; or the terminal sends the plurality of sub-questions obtained through question decomposition to a server of a search engine, and the server of the search engine queries each of the sub-questions, to obtain a reference information set of the plurality of sub-questions; and finally, the terminal inputs the question to be answered and the reference information set to a preset natural language processing model, and answers, by using the natural language processing model, the question to be answered based on reference information in the reference information set, to obtain an answer result of the question to be answered.

The question answering method provided in this embodiment of this application may alternatively be implemented based on a cloud platform and a cloud technology. For example, the foregoing server 300 may be a cloud server. The question decomposition model and the natural language processing model are trained by using the cloud server. Alternatively, question decomposition is performed on the question to be answered by using the cloud server, to obtain a plurality of sub-questions corresponding to the question to be answered, and each of the sub-questions is queried by using the cloud server, to obtain a reference information set corresponding to the plurality of sub-questions; and the question to be answered is answered by using the cloud server based on reference information in the reference information set, to obtain an answer result of the question to be answered.

In some embodiments, a cloud memory may be further provided. A model parameter of the question decomposition model and a model parameter of the natural language processing model may be stored in the cloud memory. Alternatively, the question to be answered and the answer result may also be stored in the cloud memory. Accordingly, when a question answering request for any question to be answered is received, the model parameter of the question decomposition model and the model parameter of the natural language processing model may be directly obtained from the cloud memory, and the trained question decomposition model and natural language processing model are invoked based on the obtained model parameters to answer the question to be answered, to obtain a corresponding answer result.

The cloud technology refers to a hosting technology that unifies a series of resources such as hardware, software, and networks in a wide area network or a local area network, to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required flexibly and conveniently. A cloud computing technology will become an important support. A background service of a technical network system requires a large amount of computing and storage resources, such as video websites, image websites, and more portal websites. As the Internet industry is highly developed and applied, each article may have its own identifier in the future and needs to be transmitted to a background system for logical processing. Data at different levels are separately processed, and data in various industries requires strong system support, which may be implemented through cloud computing.

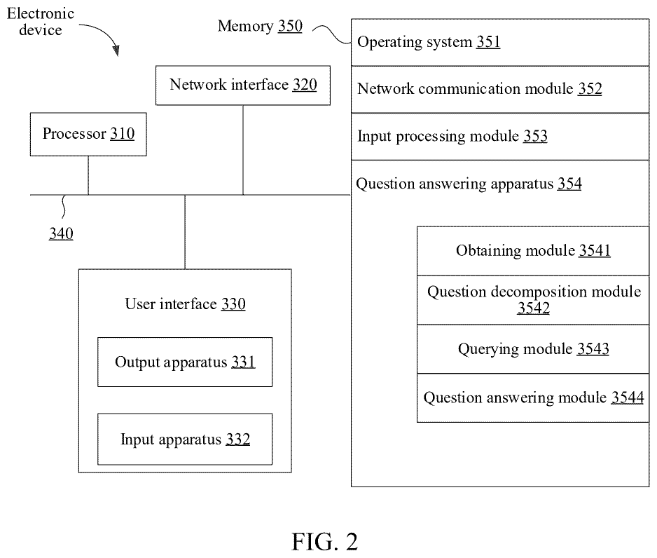

FIG. 2 is a schematic structural diagram of an electronic device according to an embodiment of this application. The electronic device shown in FIG. 2 may be a question answering device. The question answering device includes: at least one processor 310, a memory 350, at least one network interface 320, and a user interface 330. The components in the question answering device are coupled by using a bus system 340. The bus system 340 is configured to implement connection and communication between the components. In addition to a data bus, the bus system 340 further includes a power bus, a control bus, and a state signal bus. However, for ease of clear description, all types of buses in FIG. 2 are marked as the bus system 340.

The processor 310 may be an integrated circuit chip having a signal processing capability, for example, a general purpose processor, a digital signal processor (DSP), or another programmable logic device (PLD), a discrete gate, a transistor logical device, or a discrete hardware component. The general purpose processor may be a microprocessor, any conventional processor, or the like.

The user interface 330 includes one or more output apparatuses 331 and one or more input apparatuses 332 that enable presentation of media content.

The memory 350 may be a removable memory, a non-removable memory, or a combination thereof. A hardware device includes a solid-state memory, a hard disk drive, an optical disk drive, or the like. In some embodiments, the memory 350 includes one or more storage devices at a physical location far away from the processor 310. The memory 350 includes a volatile memory or a non-volatile memory, or may include both a volatile memory and a non-volatile memory. The non-volatile memory may be a read only memory (ROM). The volatile memory may be a random access memory (RAM). The memory 350 described in this embodiment of this application is to include any other suitable type of memories. In some embodiments, the memory 350 can store data to support various operations. An example of the data includes a program, a module, and a data structure or a subset or a superset thereof, which are described below by using examples.

An operating system 351 includes a system program configured to process various basic system services and perform a hardware-related task, such as a framework layer, a core library layer, or a driver layer, and is configured to implement various basic services and process a hardware-based task. A network communication module 352 is configured to reach another computing device through one or more (wired or wireless) network interfaces 320. A network interface 320 includes: bluetooth, wireless compatible authentication (WiFi), a universal serial bus (USB), or the like. An input processing module 353 is configured to detect one or more user inputs or interactions from one of the one or more input apparatuses 332 and translate the detected inputs or interactions.

In some embodiments, the apparatus provided in this embodiment of this application may be implemented by using software. FIG. 2 shows a question answering apparatus 354 stored in the memory 350. The question answering apparatus 354 may be a question answering apparatus in the electronic device, and may be software in the form of a program, a plug-in, or the like. The question answering apparatus 354 includes the following software modules: an obtaining module 3541, a question decomposition module 3542, a querying module 3543, and a question answering module 3544. The modules are logical, and therefore may be combined or further split in different manners according to an implemented function. The following will describe the functions of the modules.

In some other embodiments, the apparatus provided in this embodiment of this application may be implemented by using hardware. For example, the apparatus provided in this embodiment of this application may be a processor in the form of a hardware decoding processor, which is programmed to perform the question answering method provided in this embodiment of this application. For example, the processor in the form of the hardware decoding processor may use one or more application specific integrated circuits (ASIC), a DSP, a PLD, a complex programmable logic device (CPLD), a field-programmable gate array (FPGA), or another electronic component.

The question answering method provided in the embodiments of this application may be performed by the electronic device. The electronic device may be a server, or may be a terminal. In other words, the question answering method in the embodiments of this application may be performed by the server, or may be performed by the terminal, or may be performed through interaction between the server and the terminal.

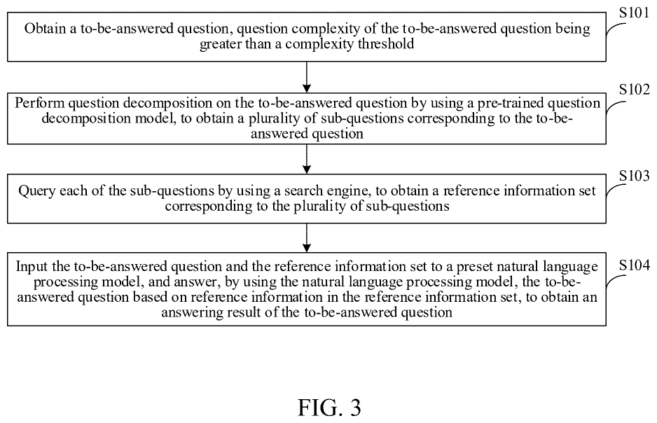

FIG. 3 is a schematic flowchart of an example of a question answering method according to an embodiment of this application. With reference to operations shown in FIG. 3, description is made below by using an example in which the question answering method is executed by the server. As shown in FIG. 3, the method includes the following operation S101 to operation S105.

Operation S101: Obtain a question to be answered, question complexity of the question to be answered being greater than a complexity threshold.

The question to be answered may be a question in a text form. A user may input a question to be answered in a speech form by using the question answering application. A server of the question answering application performs semantic recognition on the question to be answered inputted by the user in the speech form, to obtain a speech recognition result of the question to be answered; and converts the question to be answered in the speech form into a question to be answered in a text form based on the speech recognition result. Alternatively, the user may directly input a question to be answered in a text form to a client of the question answering application.

In this embodiment of this application, the question to be answered may be a complex factual question, where the complexity of the question to be answered is greater than or equal to the complexity threshold. That the complexity of the question to be answered is greater than or equal to the complexity threshold means that a length of the question to be answered is greater than or equal to a length threshold. Alternatively, that the complexity of the question to be answered is greater than or equal to the complexity threshold means that a quantity of content involved in the question to be answered is greater than a quantity threshold.

Operation S102: Perform question decomposition on the question to be answered by using a pre-trained question decomposition model, to obtain a plurality of sub-questions corresponding to the question to be answered.

The question decomposition model is a model obtained through training by using a first quantity of supervised data and a second quantity of weakly-supervised data as sample data; and the first quantity is less than the second quantity, and a particular ratio exists between the first quantity and the second quantity.

The supervised data is data obtained through manual labeling, and the quantity of supervised data is less than the quantity of the weakly-supervised data. The supervised data includes a sample question and a sample decomposed question. The sample decomposed question is a sub-question obtained after question decomposition is performed on the sample question. A filtered sample question may be decomposed in a manual labeling manner, to obtain a plurality of decomposed sub-questions.

The weakly-supervised data is a sample question and a sample decomposed question generated by using an open-source large generative language model (for example, a model such as the ChatGPT) based on an artificial intelligence technology. In this embodiment of this application, the weakly-supervised data may be constructed by using any generative language model, and may be constructed in any generation manner that can accurately generate a legal question. For example, different weakly-supervised data may be generated by using the ChatGPT model based on a zero-shot technology and a feature-shot technology.

In this embodiment of this application, supervised data needs to be manually labeled, which has a high requirement on labor costs, and weakly-supervised data may be rapidly constructed by using the generative language model. Therefore, the quantity of supervised data may be far less than the quantity of weakly-supervised data. However, to ensure that the question decomposition model can be accurately trained by using the sample data including the supervised data and the weakly-supervised data, the quantity of supervised data also needs to be ensured. Therefore, the particular ratio exists between the first quantity corresponding to the supervised data and the second quantity corresponding to the weakly-supervised data. The particular ratio may be predetermined based on a model parameter of the question decomposition model and a training task of the question decomposition model.

In some embodiments, after the question to be answered is obtained, question pre-processing may be performed on the question to be answered, to obtain a pre-processed question to be answered; and the pre-processed question to be answered is inputted to the question decomposition model, and question decomposition is performed on the pre-processed question to be answered by using the question decomposition model, to obtain a plurality of sub-questions.

The pre-processing may be processing on the question to be answered, such as correction of typos, disambiguation of semantics, and anaphora resolution brought by a plurality of rounds of dialog. In addition, some questions unsuitable for being decomposed, such as questions involving security and vulgarity, may be deleted.

In some embodiments, after the plurality of sub-questions are obtained, question post-processing may be performed on the plurality of sub-questions, to obtain a plurality of post-processed sub-questions; and the plurality of post-processed sub-questions are inputted to a search engine. The post-processing may refer to cleaning the sub-questions outputted by the question decomposition model, to improve precision. Repeated question recognition is performed on the plurality of decomposed sub-questions, and deduplication is performed on repeated questions, to reduce retrieval pressure of the downstream search engine. In addition, for some sub-questions that are improper in expression, a result may be improved in a manner of filtering or completing the sub-questions.

Operation S103: Query each of the sub-questions by using the search engine, to obtain a reference information set corresponding to the plurality of sub-questions.

In this embodiment of this application, each of the sub-questions may be inputted to the search engine for querying and searching, to obtain a corresponding search result. Content in the search result forms reference information corresponding to the sub-question. The plurality of sub-questions are separately queried and searched to correspondingly obtain a plurality of pieces of reference information. Therefore, the plurality of pieces of reference information may be collected to obtain the reference information set. The reference information set includes a plurality of pieces of different reference information.

In some embodiments, for different sub-questions, searched reference information may be the same or may be different. When the reference information found for different sub-questions is the same, the same reference information may be deleted, and only one piece of the same reference information is included in the reference information set. In other words, deduplication is performed on repeated reference information, thereby simplifying content in the reference information set.

In some embodiments, each of the sub-questions may be queried in the following manner: first, obtaining query words in each of the sub-questions; then, inputting the query words of each of the sub-questions to the search engine, and querying each of the query words by using the search engine, to obtain reference information corresponding to the sub-question; and finally, collecting reference information corresponding to all the sub-questions, to obtain the reference information set. A query word is a keyword in a sub-question. The keyword in the each of the sub-questions may be obtained by performing text recognition on the sub-question. Accordingly, querying in the search engine based on the keyword can greatly improve querying efficiency. In this embodiment of this application, the keyword in the sub-question may be recognized by using any text recognition method. For example, word segmentation processing may be first performed on the sub-question, to obtain a plurality of words; then, a part of-speech of each word in the sub-question is determined; and finally, a word with a specific part-of-speech is determined as the keyword of the sub-question.

The same sub-question may have one or more keywords. When any sub-question has a plurality of keywords, querying and searching may be performed in the search engine based on the plurality of keywords, thereby improving efficiency and accuracy of querying and searching.

Operation S104: Input the question to be answered and the reference information set to a preset natural language processing model, and answer, by using the natural language processing model, the question to be answered based on the reference information in the reference information set, to obtain an answer result of the question to be answered.

The preset natural language processing model is a question answering model. The question answering model is configured to analyze and summarize the reference information in the reference information set, to obtain the answer result corresponding to the question to be answered. In other words, the question to be answered and the reference information set may be inputted to the preset natural language processing model, and an answer configured for answering the question to be answered is outputted by using the natural language processing model with reference of the reference information in the reference information set.

According to the question answering method provided in this embodiment of this application, in one aspect, question decomposition is performed on a question to be answered by using a pre-trained question decomposition model, to obtain a plurality of sub-questions corresponding to the question to be answered. The question decomposition model is a model obtained through training by using a first quantity of supervised data and a second quantity of weakly-supervised data as sample data. Accordingly, because the first quantity is less than the second quantity, that is, the quantity of supervised data is less than the quantity of weakly-supervised data, the question decomposition model can be trained by using a small quantity of supervised data that are manually labeled and a large quantity of weakly-supervised data that do not need to be manually labeled, thereby greatly reducing difficulty and costs of constructing the sample data and improving efficiency of constructing the sample data. In another aspect, each of the sub-questions is queried by using the search engine to obtain a reference information set corresponding to the plurality of sub-questions; and the question to be answered and the reference information set are inputted to a preset natural language processing model, and the question to be answered is answered by using the natural language processing model based on reference information in the reference information set, to obtain an answer result of the question to be answered. Accordingly, querying processes of the plurality of sub-questions may be performed in parallel, and the final answer result is determined based on the reference information in the queried reference information set, thereby improving question answering efficiency, reducing resource consumption in the question answering process, and ensuring accuracy of the obtained answer result.

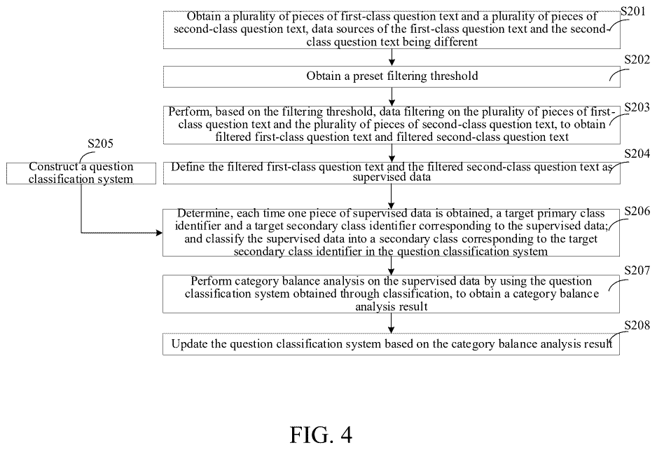

In some embodiments, the supervised data is the data obtained through manual labeling. A manner of obtaining the supervised data may be manually defined, and the server obtains the corresponding supervised data in the obtaining manner. An embodiment of this application further provides a method for obtaining the supervised data. FIG. 4 is a schematic flowchart of a method for obtaining supervised data according to an embodiment of this application. The method for obtaining supervised data may alternatively be performed by the server. As shown in FIG. 4, the method includes the following operation S201 to operation S204.

Operation S201: Obtain a plurality of pieces of first-class question text and a plurality of pieces of second-class question text, data sources of the first-class question text and the second-class question text being different.

Question text from two completely different sources may be obtained, and the supervised data is constructed by using the question text from different sources, thereby expanding data diversity of the supervised data, and avoiding that supervised data constructed by same data or similar data causes a fast model convergence speed and inaccurate model training during training of the question decomposition model. For example, user question text in the search engine and question text in community question answering may be obtained, or question text in a comment of user recommendation information may be obtained.

Operation S202: Obtain a preset filtering threshold.

In some embodiments, the filtering threshold includes a text complexity threshold and an interaction frequency threshold.

Operation S203: Perform, based on the filtering threshold, data filtering on the plurality of pieces of first-class question text and the plurality of pieces of second-class question text, to obtain filtered first-class question text and filtered second-class question text.

FIG. 5 shows that operation S203 may be implemented by using the following operation S2031 to operation S2035.

Operation S2031: Perform, according to the text complexity threshold, complexity filtering on the plurality of pieces of first-class question text and the plurality of pieces of second-class question text, to obtain at least one piece of complexity-filtered first-class question text and at least one piece of complexity-filtered second-class question text.

First-class question texts whose complexity is greater than the text complexity threshold may be defined as filtered first-class question text to form the at least one piece of complexity-filtered first-class question text. Second-class question text whose complexity is greater than the text complexity threshold is defined as filtered second-class question text to form the at least one piece of complexity-filtered second-class question text. Accordingly, complexity filtering is performed on the plurality of pieces of first-class question text and the plurality of pieces of second-class question text based on the text complexity threshold, so that complex question text can be filtered.

Operation S2032: Perform, according to the interaction frequency threshold, interaction frequency filtering on the at least one piece of complexity-filtered first-class question text, to obtain interaction frequency-filtered first-class question text.

An interaction frequency is a frequency at which the first-class question text with which the user performs interaction, for example, a quantity of times that the first-class question text is browsed by the user, a quantity of times that the first-class question text is queried, a browsing time length, or a quantity of clicks. First-class question text whose interaction frequency is greater than the interaction frequency threshold may be defined as filtered first-class question text from the at least one piece of complexity-filtered first-class question text, to form the interaction frequency-filtered first-class question text.

Operation S2033: Perform expression filtering on the at least one piece of complexity-filtered second-class question text, to obtain expression-filtered second-class question text.

The expression filtering refers to a filtering manner of determining text definiteness and text content accuracy of second-class question text. In an implementation process, text recognition may be performed on each of the at least one piece of complexity-filtered second-class question text, to analyze whether semantics of the text is clear or ambiguous, whether content of the text is accurate, and the like, to obtain an analysis result; and then, second-class question text having clear semantics and accurate content is filtered according to the analysis result, to obtain the expression-filtered second-class question text.

Operation S2034: Define the interaction frequency-filtered first-class question text as the filtered first-class question text.

Operation S2035: Define the expression-filtered second-class question text as the filtered second-class question text.

In this embodiment of this application, data filtering is separately performed on the plurality of pieces of first-class question text and the plurality of pieces of second-class question text based on the text complexity threshold and the interaction frequency threshold, to obtain the filtered first-class question text and the filtered second-class question text. Accordingly, first-class question text and second-class question text that satisfy expectations can be accurately filtered, thereby improving accuracy of the finally obtained supervised data.

Operation S204: Define the filtered first-class question text and the filtered second-class question text as the supervised data.

Still referring to FIG. 4, in some embodiments, each time one piece of supervised data is obtained, the supervised data may be added to a pre-constructed question classification system, to determine, based on the question classification system, whether to continue to obtain new supervised data, and determine to obtain which category of supervised data. Therefore, the method may further include the following operation S205 to operation S208.

Operation S205: Construct the question classification system, the question classification system including a plurality of primary classes and a plurality of secondary classes corresponding to each of the primary classes; and each of the primary classes uniquely corresponding to one primary class identifier, and each of the secondary classes uniquely corresponding to one secondary class identifier.

Operation S206: Determine, each time one piece of supervised data is obtained, a target primary class identifier and a target secondary class identifier corresponding to the supervised data; and classify the supervised data into a secondary class corresponding to the target secondary class identifier in the question classification system.

Operation S207: Perform category balance analysis on the supervised data by using the question classification system obtained through classification, to obtain a category balance analysis result.

The category balance analysis refers to analyzing whether quantities of supervised data under different categories of class identifiers in the question classification system are balanced, that is, analyzing whether a quantity of supervised data under one or more secondary classes is far greater than or far less than a quantity of supervised data under one or more other secondary classes.

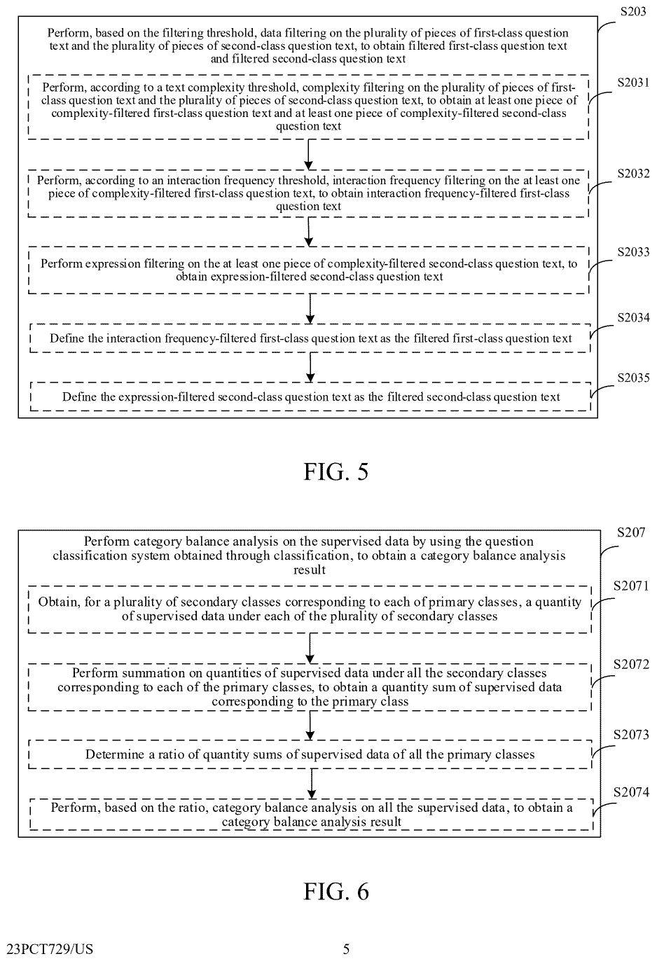

FIG. 6 shows that operation S207 may be implemented by using the following operation S2071 to operation S2074.

Operation S2071: Obtain, for the plurality of secondary classes corresponding to each of the primary classes, a quantity of supervised data under each of the plurality of secondary classes.

Operation S2072: Perform summation on quantities of supervised data under all the secondary classes corresponding to each of the primary classes, to obtain a quantity sum of supervised data corresponding to the primary class.

The quantity sum of supervised data under each of the primary classes may be calculated. A primary class has a plurality of secondary classes. Therefore, a quantity of all supervised data under the secondary classes may be calculated, that is, summation is performed on quantities of supervised data in the plurality of secondary classes, so that a quantity sum of supervised data corresponding to the primary class may be calculated.

Operation S2073: Determine a ratio of quantity sums of supervised data of all the primary classes.

Operation S2074: Perform, based on the ratio, category balance analysis on all the supervised data, to obtain a category balance analysis result.

The category balance analysis result includes that categories of all the primary classes are balanced and the categories of all the primary classes are unbalanced.

In this embodiment of this application, statistics on supervised data under each of the primary classes are implemented by calculating the quantity sums of supervised data of all the primary classes, to further determine the ratio of the quantity sums of supervised data of all the primary classes. According to the ratio, it is determined whether ratios of supervised data under different primary classes are balanced. In other words, based on the ratio, for supervised data under different primary classes, it may be determined whether a quantity of supervised data under one or more primary classes is far greater than or far less than a quantity of supervised data under other primary classes. Accordingly, next processing can be accurately performed based on the category balance analysis result, to balance quantities of supervised data under different primary classes.

Operation S208: Update the question classification system based on the category balance analysis result.

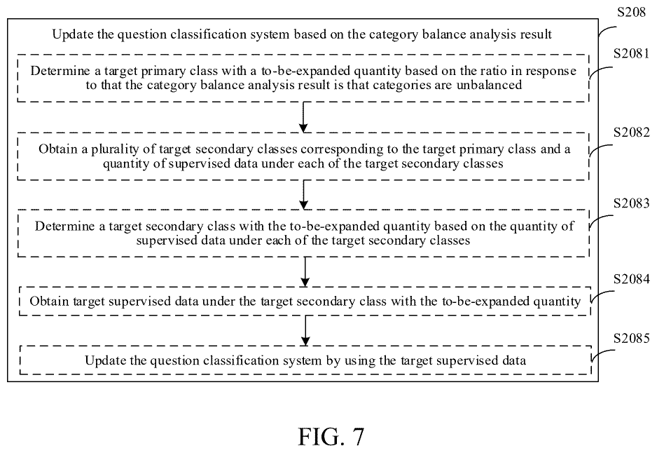

FIG. 7 shows that operation S208 may be implemented by using the following operation S2081 to operation S2085.

Operation S2081: Determine a target primary class with a quantity to be expanded based on the ratio in response to that the category balance analysis result is that the categories are unbalanced.

In this embodiment of this application, when categories of all the primary classes are unbalanced, a primary class having a smallest ratio is defined as the target primary class with the quantity to be expanded.

Operation S2082: Obtain a plurality of target secondary classes corresponding to the target primary class and a quantity of supervised data under each of the target secondary classes.

Operation S2083: Determine a target secondary class with the quantity to be expanded based on the quantity of supervised data under each of the target secondary classes.

A target secondary class having a smallest quantity of supervised data may be defined as the target secondary class with the quantity to be expanded, or a target secondary class having a quantity of supervised data less than a particular quantity threshold may be defined as the target secondary class with the quantity to be expanded.

Operation S2084: Obtain target supervised data under the target secondary class with the quantity to be expanded.

The target supervised data is supervised data not classified into the question classification system. In other words, the target supervised data is new supervised data under the target secondary class with the quantity to be expanded. The new supervised data is supervised data having the same category as the target secondary class.

Operation S2085: Update the question classification system by using the target supervised data.

In this embodiment of this application, the target secondary class with the quantity to be expanded is determined, and the new supervised data under the target secondary class is obtained. Accordingly, after the new supervised data is obtained, the new supervised data may be added to the corresponding secondary class in the question classification system, thereby expanding the supervised data of the target secondary class. In other words, the supervised data under the target secondary class having the smallest quantity of supervised data can be expanded, thereby ensuring balance between quantities of supervised data under different primary classes in the question classification system.

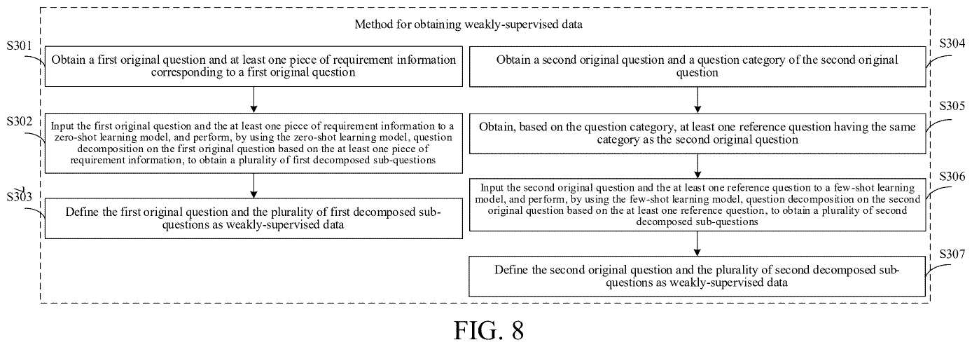

In some embodiments, the weakly-supervised data is the sample question and the sample decomposed question generated by using the open-source large generative language model based on the artificial intelligence technology. An embodiment of this application further provides a method for obtaining the weakly-supervised data. FIG. 8 is a schematic flowchart of a method for obtaining weakly-supervised data according to an embodiment of this application. As shown in FIG. 8, the method includes the following operation S301 to operation S303.

Operation S301: Obtain a first original question and at least one piece of requirement information corresponding to the first original question.

The first original question may be any question to be answered with particular complexity and fluency. The requirement information is a constraint condition that needs to be satisfied when a zero-shot learning model is required to perform question decomposition on the first original question. For example, the requirement information may be “Knowledge points for answering the question need to be decomposed, and sub-questions are constructed around these knowledge points”, “The decomposed sub-question needs to be concise (has no more than 15 words as much as possible), to be easily understood by the search engine”, “The quantity of decomposed sub-questions is no more than three”, “The decomposed sub-questions do not have anaphora dependency and semantic repetition”, and the like. The requirement information may be manually pre-defined information, and may be inputted to the zero-shot learning model together with the first original question when the first original question is obtained.

Operation S302: Input the first original question and the at least one piece of requirement information to the zero-shot learning model, and perform, by using the zero-shot learning model, question decomposition on the first original question based on the at least one piece of requirement information, to obtain a plurality of first decomposed sub-questions.

In this embodiment of this application, the zero-shot learning model performs question decomposition on the first original question according to the requirement information. In other words, a question decomposition process and the plurality of first decomposed sub-questions obtained through question decomposition need to satisfy the constraint condition corresponding to the requirement information.

In some embodiments, the zero-shot learning model may be a large generative language model that implements a language construction capability based on a zero-shot technology.

Operation S303: Define the first original question and the plurality of first decomposed sub-questions as the weakly-supervised data.

In this embodiment of this application, after the first decomposed sub-questions are obtained, the first original question forms a sample question in the weakly-supervised data, and the first decomposed sub-questions form sample decomposed questions in the weakly-supervised data. The sample question and the sample decomposed questions are combined to form one piece of weakly-supervised data.

Still referring to FIG. 8, in some other embodiments, the method for obtaining weakly-supervised data may further include the following operation S304 to operation S307. Operation S304 to operation S307 show another method for constructing the weakly-supervised data.

Operation S304: Obtain a second original question and a question category of the second original question.

The second original question may also be any question to be answered with particular complexity and fluency. The second original question may be a question in any secondary class of the question classification system. After the second original question is obtained, the question category of the second original question may be queried from the question classification system. In a querying process, a secondary class to which the second original question belongs may be first determined. Then, a question category corresponding to the secondary class is obtained, and the question category is determined as the question category of the second original question.

Operation S305: Obtain, based on the question category, at least one reference question having the same category as the second original question.

The reference question is a question having the same question category as the second original question. In this embodiment of this application, the at least one reference question having the same category as the second original question may be obtained from the pre-constructed question classification system.

In some embodiments, the reference question may be obtained in the following manner: first, obtaining the pre-constructed question classification system, the question classification system including the plurality of primary classes and the plurality of secondary classes corresponding to each of the primary classes; and each of the secondary classes having one secondary class identifier; then, querying a secondary class identifier corresponding to the question category of the second original question from the question classification system; and finally, obtaining at least one question from a secondary class corresponding to the secondary class identifier, and defining the obtained question as the reference question. In other words, querying may be performed in the question classification system, to obtain the secondary class to which the second original question belongs, and then, at least one question is obtained as the reference question of the second original question from the secondary class. Accordingly, because the reference question is queried from the pre-constructed question classification system and a plurality of questions stored in each of the secondary classes have the same question category, it can be ensured that the question category of the obtained reference question is the same as the question category of the second original question.

Operation S306: Input the second original question and the at least one reference question to a few-shot learning model, and perform, by using the few-shot learning model, question decomposition on the second original question based on the at least one reference question, to obtain a plurality of second decomposed sub-questions.

In this embodiment of this application, when the few-shot learning model performs question decomposition on the second original question, the few-shot learning model performs decomposition learning according to the reference question, to perform question decomposition on the second original question in a decomposition manner the same as that of the reference question. In other words, the question decomposition process learns and refers to the decomposition manner of the reference question. In some embodiments, the few-shot learning model may be a large generative language model that implements a language construction capability based on a few-shot technology.

Operation S307: Define the second original question and the plurality of second decomposed sub-questions as the weakly-supervised data.

In this embodiment of this application, after the second decomposed sub-questions are obtained, the second original question forms a sample question in the weakly-supervised data, and the second decomposed sub-questions form sample decomposed questions in the weakly-supervised data. The sample question and the sample decomposed questions are combined to form one piece of weakly-supervised data.

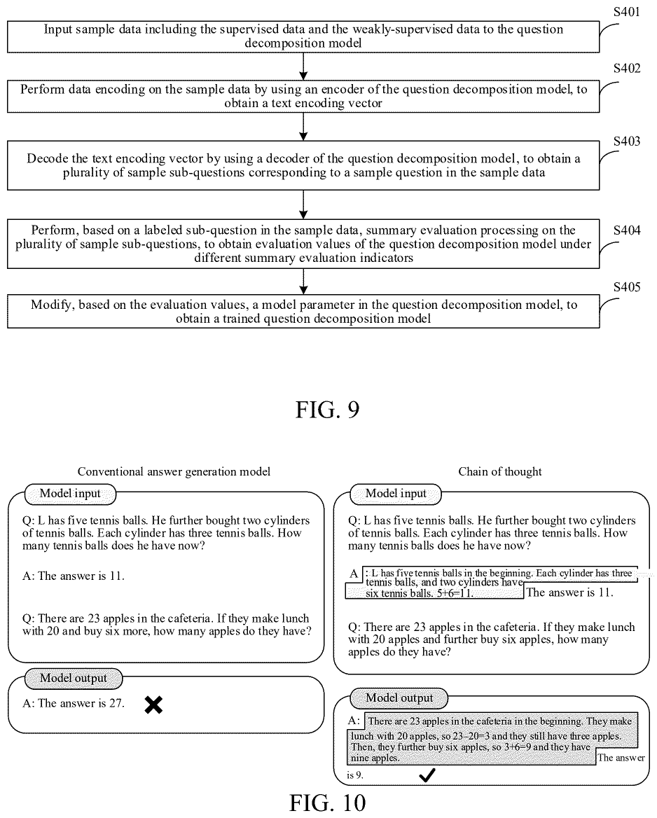

Based on the foregoing embodiments, an embodiment of this application further provides a method for training a question decomposition model. FIG. 9 is a schematic flowchart of a method for training a question decomposition model according to an embodiment of this application. The method for training a question decomposition model may be performed by using a model training module. The model training module may be a module in the question answering device (namely, the electronic device). In other words, the model training module may be the server or the terminal. Alternatively, the model training module may be another device independent of the question answering device. In other words, the model training module is another electronic device different from the foregoing server and terminal configured to implement the question answering method. As shown in FIG. 9, the method includes the following operations.

Operation S401: Input the sample data including the supervised data and the weakly-supervised data to the question decomposition model.

In this embodiment of this application, the sample data includes the supervised data and the weakly-supervised data. After the supervised data and the weakly-supervised data are mixed, the supervised data and the weakly-supervised data are configured for training the question decomposition model.

The supervised data and the weakly-supervised data both include the sample question and the sample decomposed question. The sample decomposed question is a sub-question obtained after question decomposition is performed on the sample question. One or more sample decomposed questions are provided.

Operation S402: Perform data encoding on the sample data by using an encoder of the question decomposition model, to obtain a text encoding vector.

In this embodiment of this application, the question decomposition model may use a large generative language model. The large generative language model may be a language model following a GPT architecture. In some embodiments, the large generative language model may alternatively be a language model having a pre-training parameter version. Parameter magnitudes of pre-training parameters vary from billions to hundreds of billions. Accordingly, based on the pre-training parameters in the language model having the pre-training parameter version, the large generative language model may be efficiently trained by using the supervised data and the weakly-supervised data in this embodiment of this application.

In some embodiments, a basic structural unit of the language model of the GPT architecture may be a transformer module. The transformer module mainly includes two parts: an encoder and a decoder. In this embodiment of this application, data encoding may be performed on the sample data by using the encoder, to obtain the text encoding vector.

Operation S403: Decode the text encoding vector by using a decoder of the question decomposition model, to obtain a plurality of sample sub-questions corresponding to a sample question in the sample data.

In this embodiment of this application, the text encoding vector may be decoded by using the decoder of the transformer module in the question decomposition model (that is, the language model of the GPT architecture), to obtain the plurality of sample sub-questions corresponding to the sample question in the sample data.

Operation S404: Perform, based on a labeled sub-question in the sample data, summary evaluation processing on the plurality of sample sub-questions, to obtain evaluation values of the question decomposition model under different summary evaluation indicators.

After the plurality of sample sub-questions are obtained, summary evaluation processing is performed on the plurality of sample sub-questions based on the labeled sub-question in the sample data. The summary evaluation processing refers to evaluating, under different summary evaluation indicators, differences between the sample sub-questions obtained through question decomposition and the labeled sub-question in the sample data, to obtain corresponding evaluation scores; and measuring “similarities” between the sample sub-questions obtained through question decomposition and the labeled sub-question in the sample data by using the evaluation scores.

In this embodiment of this application, different summary evaluation indicators may include recall-oriented understudy for gisting evaluation (ROUGE)-N and ROUGE-L indicators, where ROUGE is a group of indicators for evaluating automatic summaries and machine translation.

Operation S405: Modify, based on the evaluation values, a model parameter in the question decomposition model, to obtain a trained question decomposition model.

According to the method for training a question decomposition model provided in this embodiment of this application, a question decomposition model is trained based on pre-constructed supervised data and weakly-supervised data. Because costs of constructing the supervised data and the weakly-supervised data are low, costs of training the entire question decomposition model are reduced. In addition, the question decomposition model is fine-tuned by using a large amount of weakly-supervised data (because the question decomposition model may be a language model having a pre-training parameter version), to resolve the problem of few-shot cross-category failure, so that a trained question decomposition model can perform accurate question decomposition on a question to be answered of any question category.

The following describes an application of the embodiments of this application in an actual application scenario.

With the technical innovation of the ChatGPT, more and more enterprises and universities or colleges at home and abroad develop exploration of ChatGPT items. However, most models have problems in algorithm use, such as fact mistakes and fact fabrications, baseless logical or fact mistakes, and lack of richness and reasonableness, which easily mislead users.

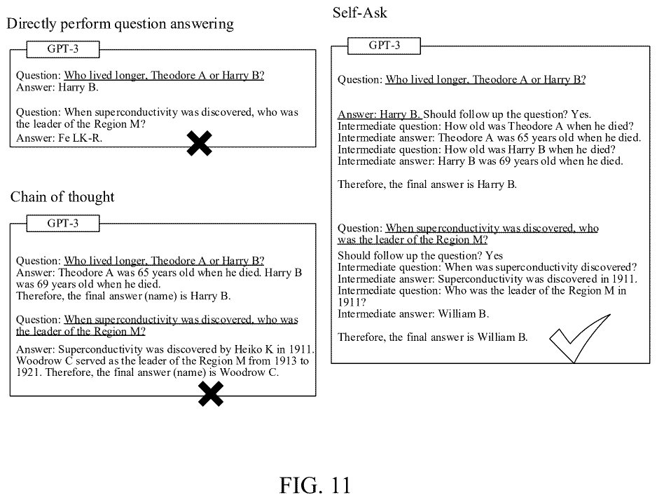

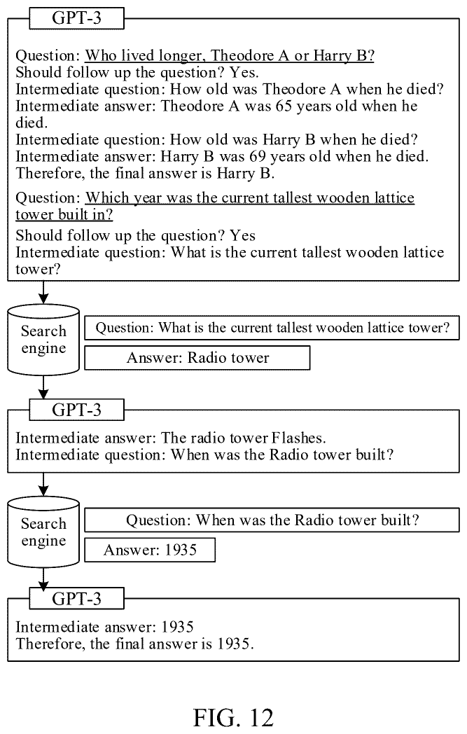

A simple means for resolving the foregoing problems is using a chain of thought. In a conventional answer generation model, an answer generation process is end-to-end answer generation. In the chain of thought method, a reasoning process of a question is decomposed into a series of related sub-questions or sub-topics. The sub-questions or sub-topics are to have a logical relationship. A final answer may be obtained by resolving some sub-questions or sub-topics and performing serial connection. FIG. 10 is a schematic diagram of a working manner of a conventional answer generation model and a chain of thought. In the ChatGPT, a logical reasoning process of the chain of thought is put into an answer in a few-shot form, to prompt a model to output the reasoning process according to a mode specified by the few-shot, rather than output only a final answer. Experiments show that a prompt of the chain of thought enables a large language model to process complex arithmetic, common sense, and symbol reasoning tasks. Another means is to improve reasoning accuracy by using a search engine result. A user question is retrieved by using the search engine, to find a search result such as a factual article and fragment. During question answering, the model generates an answer according to the search result. In addition, if the generated answer is from a searched article, the article needs to be listed for reference. The reliability of the answer of the ChatGPT is greatly increased in this means. FIG. 11 is a flowchart of a working manner of a self-ask method generated according to a search result by using a model in the related arts. Alternatively, the model is prompted in a few-shot form to make a reply in a question-specified form. In the question prompt, a complex question or a reasoning question is automatically decomposed into a plurality of sub-questions. The process is similar to the question decomposition process of the chain of thought, and a final answer can be obtained by making the model reply to the sub-questions. Each of the sub-questions needs to be decomposed by the model, and an answer to each of the sub-questions needs to be obtained by using the search engine. For example, a feature fragment is obtained from an online application programming interface (API) of the search engine, or a top-ranked question answer is obtained from the search engine. After all sub-questions and corresponding answers are obtained through a plurality of rounds of intermediate question generation and interaction with the search engine, final reasoning generation is performed by using the ChatGPT model to obtain the final answer. An overall process logic is similar to that of the chain of thought. However, through question decomposition, the answer is explicitly obtained by reasoning operation by operation, and in each operation of reasoning, a trusted answer is found by using the search engine. FIG. 12 is a schematic flowchart of a working manner of the self-ask method generated according to the search result by using the model in combination with a search engine in the related arts.

However, the solution of the chain of thought has at least the following problems. In a chain of thought solution in a model fine-tuning manner, a large number of samples with reasoning processes need to be constructed, causing high difficulty construction and high labor costs. In a chain of thought solution in a few-shot manner, it needs to be ensured that for a reference sample and a current question, distributions and categories thereof are consistent, and reasoning processes thereof are similar. Once a cross-category sample question occurs, the output effect is very poor. Relying on the model itself for reasoning without an explicit decomposition process easily causes a chain of thought mistake. Decomposition by using the self-ask method has the problems: The method has pain points similar to the chain of thought, needs to be performed in a few-shot manner, needs to keep categories and distributions consistent, and also still has a problem of sample construction. In addition, the serial time consumption is high. Because a sub-question decomposition and answering process are serial, long time is consumed. In addition, when the model is large, the overall calculation amount is excessively large, and a question decomposition sub-task cannot be independently performed.

Based on this, key problems to be resolved in the embodiments of this application are as follows:

First, a sample is constructed with low costs. A good sample question is selected through sample question engineering (prompt engineering); and a small amount of manually precisely labeled category data+decomposed data are used, and an API of ChatGPT is requested to obtain a large amount of weakly-supervised data, to construct a question decomposition sample with low costs. Second, fine tuning is performed by using a large amount of weakly-supervised data, to resolve the problem of few-shot cross-category failure. After the weakly-supervised data is obtained as the sample data through the API of the ChatGPT, an open-source large language model (LLM) is fine-tuned, to resolve a question decomposition task of any question category. Third, overall running may be parallel. A question is independently decomposed by using a small model, and answer obtaining processes of sub-questions obtained through decomposition may be parallel, thereby reducing resource consumption. The question answering method in the embodiments of this application can be applied to most ChatGPT-based items, such as an LLM-based search system, an LLM-based chatbot system, and an LLM-based voice chat system.

According to the embodiments of this application, the foregoing system can be helped to implement a case in which a user question requires external knowledge enhancement or a complex question needs to be resolved by reasoning after being decomposed. In this case, according to the embodiments of this application, the user question may be decomposed into a plurality of sub-questions of independent knowledge points. After the plurality of sub-questions are answered, a final and complete answer is collected, thereby improving answer accuracy, and reducing factual mistakes and fact fabrication caused by end-to-end reasoning of a large model. In addition, answer richness and reasonableness are improved, thereby improving user experience.

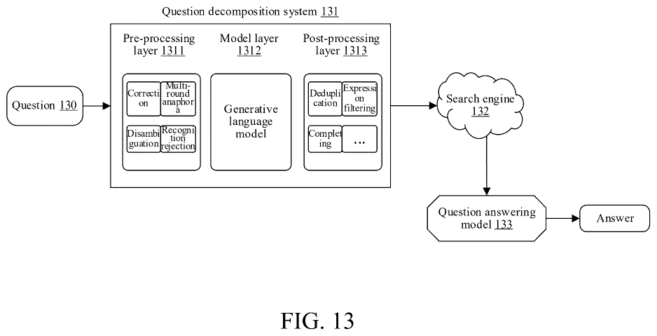

FIG. 13 is a block diagram of a question answering method according to an embodiment of this application. As shown in FIG. 13, a main function of an entire question decomposition system 131 is to split and rewrite a complex question 130 (Prompt), decompose the complex question 130 into a plurality of simple independent query words, and provide the plurality of simple independent query words to a downstream search engine 132 for retrieval. The search engine 132 inputs retrieved data to a question answering model 133 (for example, a GPT language model) for reference, thereby improving accuracy and timeliness of question answering of the question answering model 133. The entire question decomposition system 131 may be divided into three layers: a pre-processing layer 1311, a model layer 1312, and a post-processing layer 1313, which are respectively described below.

For the pre-processing layer 1311, the question decomposition system 131 inputs a user question (corresponding to the question to be answered). The question may be user generated content (UGC), that is, original content of a user. UGC data has a large amount of noise, for example, typos, ambiguity, and anaphora resolution brought by a plurality of rounds of dialog. In addition, for some questions unsuitable for being decomposed, such as questions involving security and vulgarity, the pre-processing module also needs to have a capability of rejecting recognition.

The model layer 1312 mainly takes a question decomposition work. A complex question may be decomposed into a plurality of “simple sub-questions” by using a capability of the large generative language model. For example, the question “I am studying at one bottom-ranked national 211 project university. My English is general. I want to continue my study as a postgraduate in Food Science. Can you tell me which university has lower graduate entrance exam difficulty, university A or university B?” may be decomposed into two query words: “graduate entrance exam difficulty of the university A” and graduate entrance exam difficulty of the university B”. The following describes a question decomposition resolution from two processes: sample construction and model training.

The post-processing layer 1313 mainly performs final cleaning on an output result of the model, to improve precision of the model. Deduplication needs to be performed on repeated questions in the decomposed sub-questions, to reduce retrieval pressure of the downstream search engine. For some sub-questions that are improper in expression, a result may be improved in a manner of filtering or completing.

The following describes a sample construction process in the embodiments of this application. Sample data includes supervised data and weakly-supervised data.

The supervised data may be obtained through manual labeling, to obtain high-quality precisely-labeled data. A key point of this operation is to make labeled question data distributed as widely and representatively as possible. In the embodiments of this application, two categories of data are introduced for labeling, as shown in Table 1.

TABLE 1

| Question source | Filtering manner |
|---|---|
| User question in the | Complexity filtering + interaction |
| search engine | frequency filtering |
| Community question | Complexity filtering + expression |
| answering question | filtering |

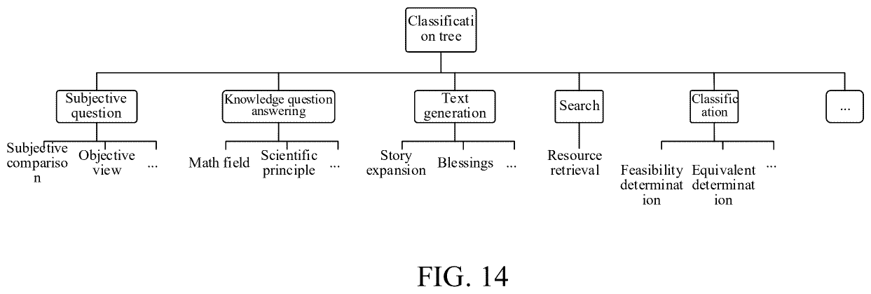

In addition, to describe reasonableness of data distribution of a question, a question classification system is further constructed in the embodiments of this application. FIG. 14 is a schematic diagram of a question classification system according to an embodiment of this application, to facilitate more work of data mining and category balancing. A total of eight large categories and 160 small categories are designed to form a classification tree system in this embodiment of this application. During labeling, the question is classified into a leaf node in the system.

For the construction of the weakly-supervised data, considering that there are many open-source large generative language models of a hundred billion scale (for example, the ChatGPT) on the Internet, the weakly-supervised data for question decomposition may be constructed by using zero-shot and few-shot capabilities of the models in the embodiments of this application. The zero-shot capability means that during natural language processing, a model can predict or execute a particular task when the model does not receive training data of the task. This means that the model may process a new task without being pre-trained for the particular task, and does not need to be trained again or fine-tuned. This capability is because the model learns general language representation and semantic knowledge in a training process. Accordingly, the model can be promoted to a new task and field. However, the key of the zero-shot capability lies in the design of the question. In the embodiments of this application, a plurality of different questions are compared, and manual evaluation is separately performed. Table 2 shows descriptions of effects of comparing different questions based on the zero-shot technology in the embodiments of this application.

TABLE 2

| Question | | | Effect |
|---|---|---|---|
| version | Question sample | Answer | description |
| v1 | Question: How can I run | OK, I can decompose the foregoing | Too long, and |
| | an educational institution | question into the following sub-questions: | not concise |
| | with only one person to | What is a category of educational | enough |
| | teach? | institutions? Is it a primary school, a middle | |
| | Decompose the foregoing | school, a university, a training institution, | |
| | question into | or an education institution of another | |
| | sub-questions. | category? | |
| | | How large is the educational institution's | |
| | | scale? Is there only one teacher or a | |
| | | plurality of teachers? | |
| | | If there is only one teacher, does the teacher | |
| | | have sufficient abilities and experience to | |
| | | teach all courses? | |
| | | If there is only one teacher, does the teacher | |
| | | have enough time and energy to deal with | |
| | | all student requirements? | |
| | | If there is only one teacher, does the teacher | |
| | | have sufficient resources and devices to | |
| | | support a teaching activity? | |
| | | What is an operating mode of the education | |
| | | institution? Teach online or offline? | |
| v2 | Question: As a | The decomposed sub-questions are as | Add a |
| | ninth-grade student, every | follows: | “requirement”, |
| | Saturday, I sleep about | What harm insufficient sleep to the body is? | to implement |
| | one a.m., but need to get | How to improve sleep quality? | more accurate |
| | up at five a.m. Is it very | | decomposition. |
| | harmful to my body? | | |
| | Decompose the foregoing | | |
| | question into a plurality of | | |
| | sub-questions. | | |
| | Requirement 1: Perform | | |
| | decomposition to obtain | | |
| | knowledge points for | | |
| | answering this question, | | |
| | and construct | | |
| | sub-questions around the | | |
| | knowledge points. | | |
| | Requirement 2: The | | |
| | decomposed sub-question | | |
| | needs to be concise (has | | |
| | no more than 15 words as | | |
| | much as possible), to be | | |
| | easily understood by the | | |
| | search engine. | | |
| | Requirement 3: The | | |
| | quantity of decomposed | | |
| | sub-questions is no more | | |
| | than three. | | |
| | Requirement 4: The | | |
| | decomposed | | |
| | sub-questions do not have | | |
| | anaphora dependency and | | |
| | semantic repetition. | | |
| v3 | Question: How can I do if | Knowledge points: social phobia, social | Adjust the |
| | I do not dare to greet | anxiety, and psychological disorders | expression, so |
| | people both in reality and | Query words: | that |
| | online? Decompose the | Symptoms of social phobia | decomposition |
| | foregoing question into a | How to overcome social phobia | better |
| | plurality of query words | Suggestions from a psychiatrist | conforms to a |
| | for the search engine. | | search |
| | Requirement 1: Perform | | scenario. |
| | decomposition to obtain | | |
| | knowledge points for | | |
| | answering this question, | | |
| | and construct query words | | |
| | around the knowledge | | |
| | points. | | |
| | Requirement 2: The | | |
| | decomposed query word | | |
| | needs to be concise (has | | |
| | no more than 15 words as | | |
| | much as possible), to be | | |
| | easily understood by the | | |
| | search engine. | | |
| | Requirement 3: The | | |
| | quantity of decomposed | | |
| | query words is no more | | |
| | than three. | | |
| | Requirement 4: The | | |
| | decomposed query words | | |
| | do not have semantic | | |
| | repetition. | | |

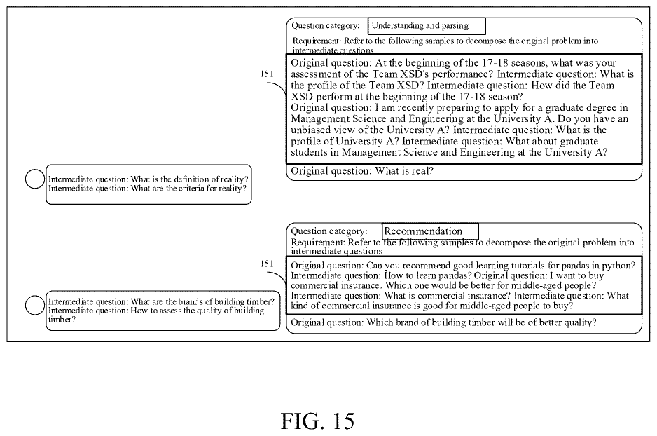

In addition, a few-shot technology is also explored in the embodiments of this application. Compared with the zero-shot technology, the few-shot technology needs to provide a plurality of pieces of sample data (namely, reference questions) in a question, so that the model can accurately perform requirement recognition. In few-shot learning, sample selection is very important. Because complexity of a question is limited, a question similar to a current question needs to be selected for sample construction in the embodiments of this application, to achieve a better few-shot prediction effect. During obtaining of the supervised data described above, question category labeling has been performed. For questions of the same category, question decomposition resolutions are usually similar. Therefore, questions of the same category may be used as a few-shot sample in the embodiments of this application. FIG. 15 is a schematic diagram of constructing weakly-supervised data based on a few-shot technology according to an embodiment of this application. Text 151 in FIG. 15 is a reference question. That the weakly-supervised data is constructed based on the few-shot technology means that a new question having the same category as the reference question is constructed based on the inputted reference question. As shown in FIG. 15, when a user asks a question of an “understanding and parsing” category, all reference questions used by the few-shot technology are questions of the “understanding and parsing” category. When the user asks a question of a “recommendation” category, all reference questions used by the few-shot technology are questions of the “recommendation” category.

The following describes a process of training the model in the model layer of the question decomposition system.

Because a question decomposition task belongs to text generation, a text generation model needs to be configured for modeling. Currently, large generative language models with good effects basically follow the GPT architecture, and many pre-training parameter versions emerge with parameter magnitudes from billions to hundreds of billions. A basic structural unit of a GPT is a transformer module, mainly including two parts: an encoder and a decoder.

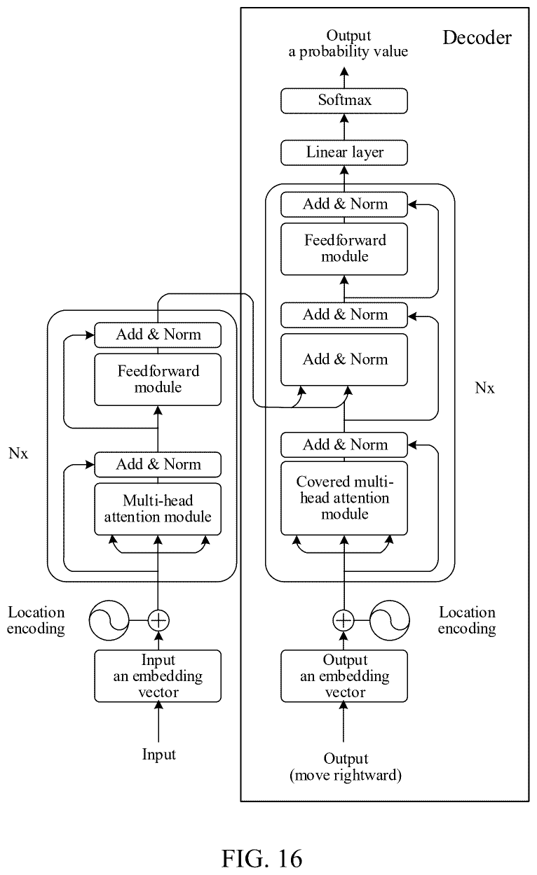

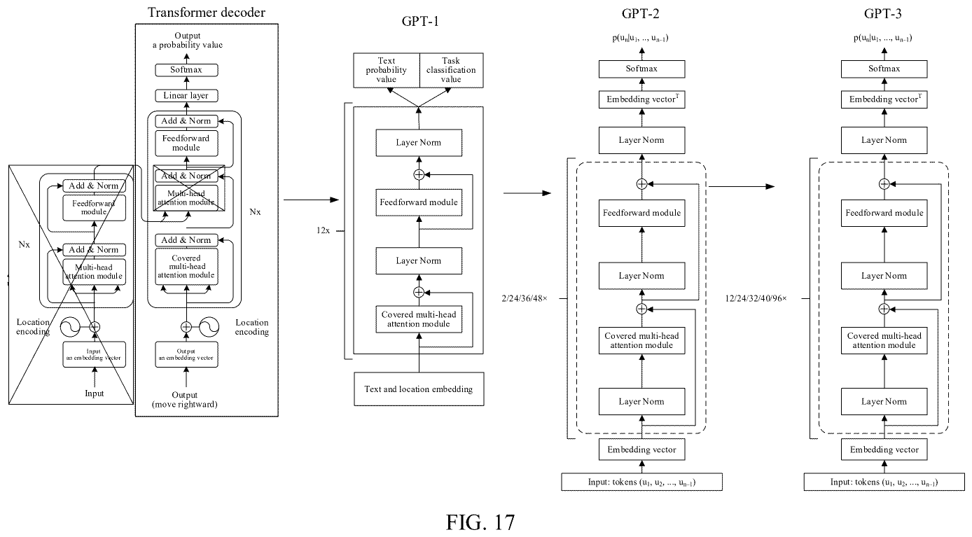

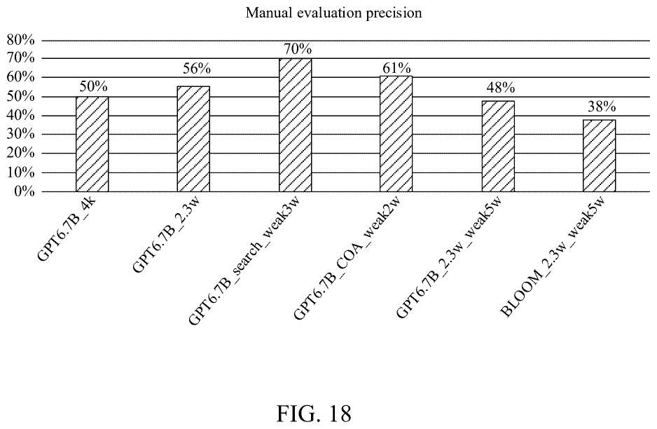

FIG. 16 is a schematic structural diagram of a transformer model according to an embodiment of this application. An encoder is a bidirectional attention encoder, providing a capability of understanding a source language. A decoder is a unidirectional attention encoder, which ensures that only the preceding text is seen, and generates a target language word by word. FIG. 17 is a schematic diagram of evolution of a GPT model. The GPT model is a language model constructed based on the transformer-decoder, and has three evolution versions: a GPT1, a GPT2, and a GPT3. Compared with the GPT1 and the GPT2, in addition to increasing in a training corpus scale and a model parameter, the GPT3 further performs fine tuning on a model structure. In other words, a dense attention mechanism in the transform-decoder is changed into a sparse attention mechanism, to accelerate model training. The question decomposition system in the embodiments of this application performs experimental comparison by using a TEG-HY-6.7B model constructed based on a GPT module and an open-source Bloom_6.7B model. In terms of experimental indicators, ROUGE-N and ROUGE-L indicators common in generation models are mainly used. However, due to diversity of natural languages, a machine evaluation indicator can only be used as a reference for stability of a model, and final experimental effects still require manual evaluation on generation precision. FIG. 18 is a comparison diagram between experimental effects of different models used by a question decomposition system according to an embodiment of this application. Table 3 shows descriptions of versions of the different models used by the question decomposition system.

TABLE 3

| Model name | Description |
|---|---|
| GPT6.7B_4k | Model = TEG_GPT_6.7B, and precisely-labeled data volume = 4k |
| GPT6.7B_2.3w | Model = TEG_GPT_6.7B, and precisely-labeled data volume = 2.3w |
| GPT6.7B_search_weak3w | Model = TEG_GPT_6.7B, and weakly-supervised data volume in a |
| | search scenario = 3w |
| GPT6.7B_CQA_weak2w | Model = TEG_GPT_6.7B, and weakly-supervised data volume in a |
| | CQA scenario = 3w |
| GPT6.7B_2.3w_weak5w | Model = TEG_GPT_6.7B, precisely-labeled data volume = 2.3w, |
| | and weakly-supervised data volume = 3w |
| BLOOM_2.3w_weak5w | Model = BLoom_6.7B, precisely-labeled data volume = 2.3w, and |
| | weakly-supervised data volume = 3w |

In a process of fine tuning the generation model used in the model layer of the question decomposition system, effects of different questions are also compared in the embodiments of this application, referring to Table 4 below.

TABLE 4

| Question | | GPT6.7B_2.3w_weak5w | BLOOM_2.3w_weak5w |
|---|---|---|---|
| version | Specific sample | precision | precision |
| v1 | Prompt = original | Same | Same |
| | question: “[original prompt]”; and | | |
| | decompose the question into a | | |
| | plurality of sub-questions: | | |
| v2 | Prompt = question: “[original | +3% | +5% |
| | prompt]”; and decompose the | | |
| | question into a plurality of query | | |
| | words for the search engine | | |
| | Requirement 1: Perform | | |
| | decomposition to obtain | | |
| | knowledge points for answering | | |
| | the question, and construct query | | |
| | words around the knowledge | | |
| | points | | |
| | Requirement 2: The decomposed | | |
| | query word needs to be concise | | |
| | (has no more than 15 words as | | |
| | much as possible), to be easily | | |
| | understood by the search engine | | |
| | Requirement 3: The quantity of | | |
| | decomposed query words is no | | |
| | more than three | | |
| | Requirement 4: The decomposed | | |
| | query words do not have semantic | | |
| | repetition | | |

It can be seen from Table 4 that, by improving the question, there are different degrees of precision improvements under the TEG_GPT_6.7B model and the BLoom_6.7B model. It is effectively indicated that using a question manner more satisfying an expression habit of the model can make the model trained better during fine tuning.

Based on the foregoing embodiments, the question decomposition system is put into operation in the embodiments of this application, thereby effectively improving an answering effect of a downstream question answering system. In view of the whole, after the question decomposition module corresponding to the question decomposition system is added to the question answering system, there are mainly two benefits: The answer richness and the reasonableness of answer organization are higher.

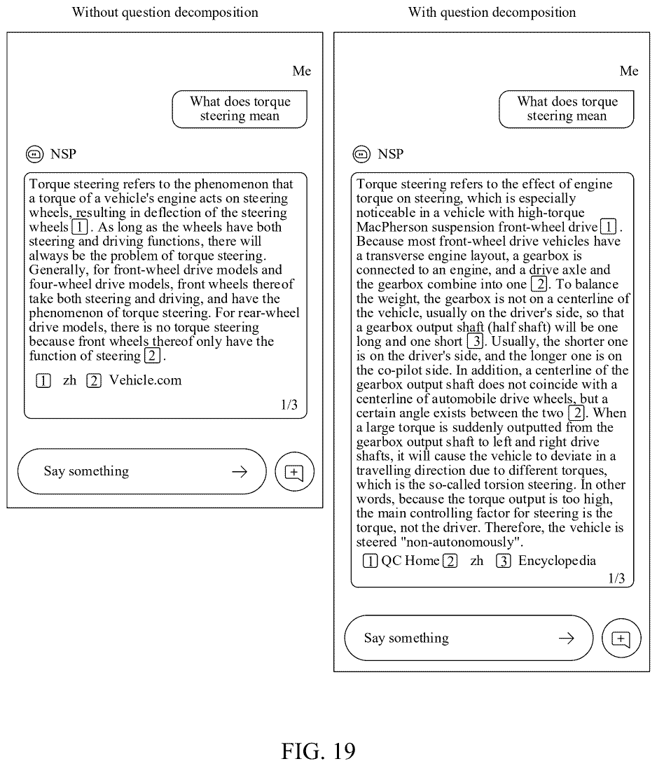

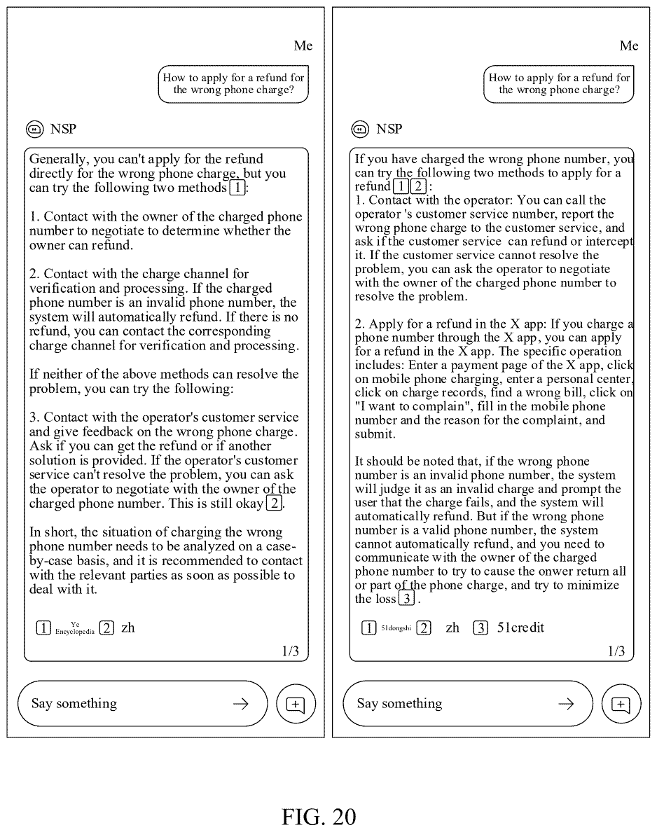

For the answer richness improvement, referring to FIG. 19, FIG. 19 is a comparison diagram between answer richness without question decomposition and answer richness with question decomposition according to an embodiment of this application. The answer richness with question decomposition is higher than the answer richness without question decomposition. For the answer reasonableness improvement, referring to FIG. 20, FIG. 20 is a comparison diagram between answer reasonableness without question decomposition and answer reasonableness with question decomposition according to an embodiment of this application. The answer reasonableness with question decomposition is higher than the answer reasonableness without question decomposition.

In the embodiments of this application, content of user information includes information such as a question to be answered of a user and an answer result of the question to be answered. If data related to the user information or enterprise information is involved, when the embodiments of this application are applied to a specific product or technology, user permission or consent needs to be obtained. In addition, when the related data collection and processing are applied in an example, informed consent or independent consent of a subject of personal information is to be obtained strictly according to requirements of related national laws and regulations. In addition, subsequent data use and processing are performed within the laws and regulations and the authorization scope of the subject of personal information.

The following continues to describe a structure in which the question answering apparatus 354 provided in the embodiments of this application is implemented as a software module. In some embodiments, as shown in FIG. 2, the question answering apparatus 354 includes the obtaining module 3541, the question decomposition module 3542, the querying module 3543, and the question answering module 3544. The obtaining module 3541 is configured to obtain a question to be answered, question complexity of the question to be answered being greater than a complexity threshold. The question decomposition module 3542 is configured to perform question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a particular ratio existing between the first quantity and the second quantity. The querying module 3543 is configured to query each of the sub-questions by using a search engine, to obtain a reference information set of the plurality of sub-questions. The question answering module 3544 is configured to input the question to be answered and the reference information set to a preset natural language processing model, and answer, by using the natural language processing model, the question to be answered based on reference information in the reference information set, to obtain an answer result of the question to be answered.

In some embodiments, the apparatus further includes a supervised data obtaining module, configured to obtain a plurality of pieces of first-class question text and a plurality of pieces of second-class question text, text data sources of the first-class question text and the second-class question text being different; separately perform, based on a preset filtering threshold, data filtering on the plurality of pieces of first-class question text and the plurality of pieces of second-class question text, to obtain filtered first-class question text and filtered second-class question text; and define the filtered first-class question text and the filtered second-class question text as the supervised data.

In some embodiments, the filtering threshold includes a text complexity threshold and an interaction frequency threshold; and the supervised data obtaining module is further configured to perform, according to the text complexity threshold, complexity filtering on the plurality of pieces of first-class question text and the plurality of pieces of second-class question text, to obtain complexity-filtered first-class question text and complexity-filtered second-class question text; perform, according to the interaction frequency threshold, interaction frequency filtering on the complexity-filtered first-class question text, to obtain interaction frequency-filtered first-class question text; perform expression filtering on the complexity-filtered second-class question text, to obtain expression-filtered second-class question text; define the interaction frequency-filtered first-class question text as the filtered first-class question text; and define the expression-filtered second-class question text as the filtered second-class question text.

In some embodiments, the apparatus further includes a question classification system construction module, configured to construct a question classification system, the question classification system including a plurality of primary classes and a plurality of secondary classes corresponding to each of the primary classes; and each of the secondary classes having one secondary class identifier; determine, when one piece of supervised data is obtained, a target primary class identifier and a target secondary class identifier corresponding to the supervised data; and classify the supervised data into a secondary class corresponding to the target secondary class identifier in the question classification system; perform category balance analysis on all supervised data in the question classification system by using the question classification system obtained through classifying the supervised data, to obtain a category balance analysis result; and update the question classification system based on the category balance analysis result.

In some embodiments, the question classification system construction module is further configured to obtain, for the plurality of secondary classes corresponding to each of the primary classes, a quantity of supervised data under each of the plurality of secondary classes; perform summation on quantities of supervised data under all the secondary classes corresponding to each of the primary classes, to obtain a quantity sum of the supervised data corresponding to the primary class; determine a ratio of quantity sums of supervised data of all the primary classes; and perform, based on the ratio, category balance analysis on all the supervised data, to obtain the category balance analysis result, the category balance analysis result including that categories of all the primary classes are balanced and the categories of all the primary classes are unbalanced.

In some embodiments, the question classification system construction module is further configured to determine a target primary class with a quantity to be expanded in response to that the category balance analysis result is that the categories are unbalanced; obtain a plurality of target secondary classes corresponding to the target primary classes and a quantity of supervised data under each of the target secondary classes; determine a target secondary class with the quantity to be expanded based on the quantity of supervised data under each of the target secondary classes; obtain target supervised data under the target secondary class with the quantity to be expanded, the target supervised data being supervised data not classified into the question classification system; and update the question classification system by using the target supervised data.

In some embodiments, the apparatus further includes a first weakly-supervised data obtaining module, configured to obtain a first original question and at least one piece of requirement information corresponding to the first original question; input the first original question and the at least one piece of requirement information to a zero-shot learning model, and perform, by using the zero-shot learning model, question decomposition on the first original question based on the at least one piece of requirement information, to obtain a plurality of first decomposed sub-questions; and define the first original question and the plurality of first decomposed sub-questions as the weakly-supervised data.

In some embodiments, the apparatus further includes a second weakly-supervised data obtaining module, configured to obtain a second original question and a question category of the second original question; obtain, based on the question category, at least one reference question having the same category as the second original question; input the second original question and the at least one reference question to a few-shot learning model, and perform, by using the few-shot learning model, question decomposition on the second original question based on the at least one reference question, to obtain a plurality of second decomposed sub-questions; and define the second original question and the plurality of second decomposed sub-questions as the weakly-supervised data.

In some embodiments, the second weakly-supervised data obtaining module is further configured to obtain the pre-constructed question classification system, the question classification system including the plurality of primary classes and the plurality of secondary classes corresponding to each of the primary classes; and each of the secondary classes having one secondary class identifier; query a secondary class identifier corresponding to the question category of the second original question from the question classification system; and obtain at least one question from a secondary class corresponding to the secondary class identifier, and define the obtained question as the reference question.

In some embodiments, the apparatus further includes a model training module, configured to train the question decomposition model in the following manner: inputting the sample data including the supervised data and the weakly-supervised data to the question decomposition model; performing data encoding on the sample data by using an encoder of the question decomposition model, to obtain a text encoding vector; decoding the text encoding vector by using a decoder of the question decomposition model, to obtain a plurality of sample sub-questions corresponding to a sample question in the sample data; performing, based on a labeled sub-question in the sample data, summary evaluation processing on the plurality of sample sub-questions, to obtain evaluation values of the question decomposition model under different summary evaluation indicators; and modifying, based on the evaluation values, a model parameter in the question decomposition model, to obtain a trained question decomposition model.

In some embodiments, the querying module is further configured to obtain query words in each of the sub-questions; input the query words of each of the sub-questions to the search engine, and query each of the query words by using the search engine, to obtain reference information corresponding to the sub-question; and collect reference information corresponding to all the sub-questions, to obtain the reference information set.

In some embodiments, the apparatus further includes a question pre-processing module, configured to perform, after the question to be answered is obtained, question pre-processing on the question to be answered, to obtain a pre-processed question to be answered; and input the pre-processed question to be answered to the question decomposition model, and performing question decomposition on the pre-processed question to be answered by using the question decomposition model, to obtain the plurality of sub-questions; and a question post-processing module, configured to perform, after the plurality of sub-questions are obtained, question post-processing on the plurality of sub-questions, to obtain a plurality of post-processed sub-questions, and input the plurality of post-processed sub-questions to the search engine.

The descriptions of the apparatus in the embodiments of this application are similar to the descriptions of the foregoing method embodiments and have beneficial effects similar to those of the method embodiments. Therefore, details are not described. For technical details undisclosed in the apparatus embodiments, reference is made to descriptions of the method embodiments of this application.

An embodiment of this application provides a computer program product, including executable instructions. The executable instructions are computer instructions. The executable instructions are stored in a computer-readable storage medium. When a processor of an electronic device reads the executable instructions from the computer-readable storage medium and executes the executable instructions, the electronic device is caused to perform the foregoing method in the embodiments of this application.

An embodiment of this application provides a storage medium, having executable instructions stored therein. When the executable instructions are executed by a processor, the processor is caused to perform the method in the embodiments of this application, for example, the method shown in FIG. 3.

In some embodiments, the storage medium may be a computer-readable storage medium, for example, a ferromagnetic random access memory (FRAM), a read only memory (ROM), a programmable read only memory (PROM), an erasable programmable read only memory (EPROM), an electrically erasable programmable read only memory (EEPROM), a flash memory, a magnetic surface memory, an optical disc, or a compact disk-read only memory (CD-ROM). Alternatively, the storage medium may be any device including one of or any combination of the foregoing memories.

In some embodiments, the executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the executable instructions may, but do not necessarily, correspond to a file in a file system, and may be stored in a part of a file that saves another program or other data, for example, be stored in one or more scripts in a hyper text markup language (HTML) file, stored in a single file that is specially configured for a program in discussion, or stored in a plurality of collaborative files (for example, be stored in files of one or modules, subprograms, or code parts). In an example, the executable instructions may be deployed to be executed on the electronic device, or deployed to be executed on a plurality of electronic devices at the same location, or deployed to be executed on a plurality of electronic devices that are distributed in a plurality of locations and interconnected by using a communication network.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A question answering method, performed by an electronic device, the method comprising:
obtaining a question to be answered, question complexity of the question to be answered being greater than a complexity threshold;
performing question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a ratio existing between the first quantity and the second quantity;
querying each of the sub-questions by using a search engine, to obtain a reference information set of the plurality of sub-questions;
inputting the question to be answered and the reference information set to a preset natural language processing model; and
answering the question to be answered based on reference information in the reference information set by using the natural language processing model, to obtain an answer result of the question to be answered.

2. The method according to claim 1, further comprising obtaining the supervised data by:
obtaining a plurality of pieces of first-class question text and a plurality of pieces of second-class question text, text data sources of the first-class question text and the second-class question text being different;
separately performing data filtering on the plurality of pieces of first-class question text and the plurality of pieces of second-class question text based on a preset filtering threshold, to obtain filtered first-class question text and filtered second-class question text; and
defining the filtered first-class question text and the filtered second-class question text as the supervised data.

3. The method according to claim 2, wherein the filtering threshold comprises a text complexity threshold and an interaction frequency threshold; and
the separately performing data filtering on the plurality of pieces of first-class question text and the plurality of pieces of second-class question text based on a preset filtering threshold, to obtain filtered first-class question text and filtered second-class question text comprises:
performing complexity filtering on the plurality of pieces of first-class question text and the plurality of pieces of second-class question text according to the text complexity threshold, to obtain complexity-filtered first-class question text and complexity-filtered second-class question text;
performing interaction frequency filtering on the complexity-filtered first-class question text according to the interaction frequency threshold, to obtain interaction frequency-filtered first-class question text;
performing expression filtering on the complexity-filtered second-class question text, to obtain expression-filtered second-class question text;
defining the interaction frequency-filtered first-class question text as the filtered first-class question text; and
defining the expression-filtered second-class question text as the filtered second-class question text.

4. The method according to claim 1, further comprising:
constructing a question classification system, the question classification system comprising a plurality of primary classes and a plurality of secondary classes corresponding to each of the primary classes, and each of the secondary classes having one secondary class identifier;
determining a target primary class identifier and a target secondary class identifier corresponding to the supervised data when one piece of supervised data is obtained, and classifying the supervised data into a secondary class corresponding to the target secondary class identifier in the question classification system;
performing category balance analysis on all supervised data in the question classification system by using the question classification system obtained through classifying the supervised data, to obtain a category balance analysis result; and
updating the question classification system based on the category balance analysis result.

5. The method according to claim 4, wherein the performing, category balance analysis on all supervised data in the question classification system by using the question classification system obtained by classifying the supervised data, to obtain a category balance analysis result comprises:
obtaining a quantity of supervised data under each of the plurality of secondary classes for the plurality of secondary classes corresponding to each of the primary classes;
performing summation on quantities of supervised data under all the secondary classes corresponding to each of the primary classes, to obtain a quantity sum of the supervised data corresponding to the primary class;
determining a ratio of quantity sums of supervised data of all the primary classes; and
performing category balance analysis on all the supervised data based on the ratio, to obtain the category balance analysis result, the category balance analysis result comprising that categories of all the primary classes are balanced and the categories of all the primary classes are unbalanced.

6. The method according to claim 5, wherein the updating the question classification system based on the category balance analysis result comprises:
determining a target primary class with a quantity to be expanded in response to that the category balance analysis result is that the categories are unbalanced;
obtaining a plurality of target secondary classes corresponding to the target primary classes and a quantity of supervised data under each of the target secondary classes;
determining a target secondary class with the quantity to be expanded based on the quantity of supervised data under each of the target secondary classes;
obtaining target supervised data under the target secondary class with the quantity to be expanded, the target supervised data being supervised data not classified into the question classification system; and
updating the question classification system by using the target supervised data.

7. The method according to claim 1, further comprising: obtaining the weakly-supervised data in the following manner:
obtaining a first original question and at least one piece of requirement information corresponding to the first original question;
inputting the first original question and the at least one piece of requirement information to a zero-shot learning model, and performing, by using the zero-shot learning model, question decomposition on the first original question based on the at least one piece of requirement information, to obtain a plurality of first decomposed sub-questions; and
defining the first original question and the plurality of first decomposed sub-questions as the weakly-supervised data.

8. The method according to claim 1, further comprising: obtaining the weakly-supervised data in the following manner:
obtaining a second original question and a question category of the second original question;
obtaining, based on the question category, at least one reference question having the same category as the second original question;
inputting the second original question and the at least one reference question to a few-shot learning model, and performing question decomposition on the second original question based on the at least one reference question by using the few-shot learning model, to obtain a plurality of second decomposed sub-questions; and
defining the second original question and the plurality of second decomposed sub-questions as the weakly-supervised data.

9. The method according to claim 8, wherein the obtaining, based on the question category, at least one reference question having the same category as the second original question comprises:
obtaining the pre-constructed question classification system, the question classification system comprising the plurality of primary classes and the plurality of secondary classes corresponding to each of the primary classes; and each of the secondary classes having one secondary class identifier;
querying a secondary class identifier corresponding to the question category of the second original question from the question classification system; and
obtaining at least one question from a secondary class corresponding to the secondary class identifier, and defining the obtained question as the reference question.

10. The method according to claim 1, further comprising: training the question decomposition model in the following manner:
inputting the sample data comprising the supervised data and the weakly-supervised data to the question decomposition model;
performing data encoding on the sample data by using an encoder of the question decomposition model, to obtain a text encoding vector;
decoding the text encoding vector by using a decoder of the question decomposition model, to obtain a plurality of sample sub-questions corresponding to a sample question in the sample data;
performing summary evaluation processing on the plurality of sample sub-questions based on a labeled sub-question in the sample data, to obtain evaluation values of the question decomposition model under different summary evaluation indicators; and
modifying, based on the evaluation values, a model parameter in the question decomposition model, to obtain a trained question decomposition model.

11. The method according to claim 1, wherein the querying each of the sub-questions by using a search engine, to obtain a reference information set of the plurality of sub-questions comprises:
obtaining query words in each of the sub-questions;
inputting the query words of each of the sub-questions to the search engine, and querying each of the query words by using the search engine, to obtain reference information corresponding to the sub-question; and
collecting reference information corresponding to all the sub-questions, to obtain the reference information set.

12. The method according to claim 1, wherein the method further comprises:
performing, after the question to be answered is obtained, question pre-processing on the question to be answered, to obtain a pre-processed question to be answered; and
the performing question decomposition on the question to be answered by using a pre-trained question decomposition model, to obtain a plurality of sub-questions corresponding to the question to be answered comprises:
inputting the pre-processed question to be answered to the question decomposition model, and performing question decomposition on the pre-processed question to be answered by using the question decomposition model, to obtain the plurality of sub-questions; and
performing question post-processing on the plurality of sub-questions, to obtain a plurality of post-processed sub-questions after the plurality of sub-questions are obtained, and inputting the plurality of post-processed sub-questions to the search engine.

13. An electronic device, comprising a memory, configured to store executable instructions, and a processor, configured to implement, when executing the executable instructions stored in the memory, a question answering method, the method comprising:
obtaining a question to be answered, question complexity of the question to be answered being greater than a complexity threshold;
performing question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a ratio existing between the first quantity and the second quantity;
querying each of the sub-questions by using a search engine, to obtain a reference information set of the plurality of sub-questions;
inputting the question to be answered and the reference information set to a preset natural language processing model; and
answering the question to be answered based on reference information in the reference information set by using the natural language processing model, to obtain an answer result of the question to be answered.

14. The electronic device according to claim 13, the method further comprising obtaining the supervised data by:
obtaining a plurality of pieces of first-class question text and a plurality of pieces of second-class question text, text data sources of the first-class question text and the second-class question text being different;
separately performing data filtering on the plurality of pieces of first-class question text and the plurality of pieces of second-class question text based on a preset filtering threshold, to obtain filtered first-class question text and filtered second-class question text; and
defining the filtered first-class question text and the filtered second-class question text as the supervised data.

15. The electronic device according to claim 14, wherein the filtering threshold comprises a text complexity threshold and an interaction frequency threshold; and
the separately performing data filtering on the plurality of pieces of first-class question text and the plurality of pieces of second-class question text based on a preset filtering threshold, to obtain filtered first-class question text and filtered second-class question text comprises:
performing complexity filtering on the plurality of pieces of first-class question text and the plurality of pieces of second-class question text according to the text complexity threshold, to obtain complexity-filtered first-class question text and complexity-filtered second-class question text;
performing interaction frequency filtering on the complexity-filtered first-class question text according to the interaction frequency threshold, to obtain interaction frequency-filtered first-class question text;
performing expression filtering on the complexity-filtered second-class question text, to obtain expression-filtered second-class question text;
defining the interaction frequency-filtered first-class question text as the filtered first-class question text; and
defining the expression-filtered second-class question text as the filtered second-class question text.

16. The electronic device according to claim 13, the method further comprising:
constructing a question classification system, the question classification system comprising a plurality of primary classes and a plurality of secondary classes corresponding to each of the primary classes, and each of the secondary classes having one secondary class identifier;
determining a target primary class identifier and a target secondary class identifier corresponding to the supervised data when one piece of supervised data is obtained, and classifying the supervised data into a secondary class corresponding to the target secondary class identifier in the question classification system;
performing category balance analysis on all supervised data in the question classification system by using the question classification system obtained through classifying the supervised data, to obtain a category balance analysis result; and
updating the question classification system based on the category balance analysis result.

17. The electronic device according to claim 16, wherein the performing, category balance analysis on all supervised data in the question classification system by using the question classification system obtained by classifying the supervised data, to obtain a category balance analysis result comprises:
obtaining a quantity of supervised data under each of the plurality of secondary classes for the plurality of secondary classes corresponding to each of the primary classes;
performing summation on quantities of supervised data under all the secondary classes corresponding to each of the primary classes, to obtain a quantity sum of the supervised data corresponding to the primary class;
determining a ratio of quantity sums of supervised data of all the primary classes; and
performing category balance analysis on all the supervised data based on the ratio, to obtain the category balance analysis result, the category balance analysis result comprising that categories of all the primary classes are balanced and the categories of all the primary classes are unbalanced.

18. The electronic device according to claim 17, wherein the updating the question classification system based on the category balance analysis result comprises:
determining a target primary class with a quantity to be expanded in response to that the category balance analysis result is that the categories are unbalanced;
obtaining a plurality of target secondary classes corresponding to the target primary classes and a quantity of supervised data under each of the target secondary classes;
determining a target secondary class with the quantity to be expanded based on the quantity of supervised data under each of the target secondary classes;
obtaining target supervised data under the target secondary class with the quantity to be expanded, the target supervised data being supervised data not classified into the question classification system; and
updating the question classification system by using the target supervised data.

19. A non-transitory computer-readable storage medium, having executable instructions stored therein, the computer-readable storage medium being configured to cause a processor to implement a question answering method, the method comprising:
obtaining a question to be answered, question complexity of the question to be answered being greater than a complexity threshold;
performing question decomposition on the question to be answered by using a pre-trained question decomposition model, to obtain a plurality of sub-questions corresponding to the question to be answered, the question decomposition model being a model obtained through training by using a first quantity of supervised data and a second quantity of weakly-supervised data as sample data; and the first quantity being less than the second quantity, and a ratio existing between the first quantity and the second quantity;
querying each of the sub-questions by using a search engine, to obtain a reference information set of the plurality of sub-questions;
inputting the question to be answered and the reference information set to a preset natural language processing model; and
answering the question to be answered based on reference information in the reference information set by using the natural language processing model, to obtain an answer result of the question to be answered.

20. The computer-readable storage medium according to claim 19, the method further comprising obtaining the supervised data by:
obtaining a plurality of pieces of first-class question text and a plurality of pieces of second-class question text, text data sources of the first-class question text and the second-class question text being different;
separately performing data filtering on the plurality of pieces of first-class question text and the plurality of pieces of second-class question text based on a preset filtering threshold, to obtain filtered first-class question text and filtered second-class question text; and
defining the filtered first-class question text and the filtered second-class question text as the supervised data.
